(19) United States
(12) Patent Application Publication
(10) Pub. No.: US 2006/0005486 A1
(43) Pub. Date: Jan. 12, 2006

(54) Sealing system

(76) Inventor: Gerard Francis Robinson, Dublin (IE)

Correspondence Address: SNELL & WILMER LLP, 600 ANTON BOULEVARD, SUITE 1400, COSTA MESA, CA, 92626, US

(21) Appl. No.: 10/530,223

(22) PCT Filed: Oct. 6, 2003
(86) PCT No.: PCT/IE03/00139

§ 371 Date: Apr. 4, 2005

(30) Foreign Application Priority Data
Oct. 4, 2002 (GB) 0223025.8
Jan. 6, 2003 (IE) S2003/0005

(51) Int. Cl. E06B 1/04

(52) U.S. Cl. 52/211

(57) ABSTRACT

A sealing system comprises a semi-flexible longitudinal strip (10) profile and a sealing material both adapted to maintain a sealed joint between typically relatively vertical and horizontal surfaces. The strip profile (10) comprises a first upper limb (11) having an upper limb upper boundary (12) and an upper limb lower boundary (13) between which there extends an upper limb inner face (14) and an upper limb outer face (18). From the upper limb inner face (14) and/or upper limb boundaries (19) there extends at least one second outer limb (20) having an outer limb inner boundary attached to the upper limb (18) and an outer limb outer boundary (33) between which outer limb boundaries there extends an outer limb upper face (25) and an outer limb lower face (26). A third inner limb and/or filler material is adapted to sealingly engage uncured sealing material and to aid the isolation of the uncured sealing material from the upper limb inner face (17) and/or the outer limb lower face (20).

The present invention relates to a sealing system for sealing the joint between two contiguous surfaces disposed at an angle to each other, such as, but not limited to the horizontal joint between a wall and a shower tray or bath.

The main prior art methods of sealing the junction of walls and horizontal surfaces (such as shower trays, baths and worktops) are as follows.

METHOD A: A Semi-rigid substantially L profiled sealing strip with flexible sealing lips attached to the upper most and/or outer most boundaries is installed against the vertical surface to form a pressure seal with horizontal surface as described by GB 2136288A.

METHOD B: A sealant material (typically silicone) is extruded into over the joint.

METHOD C: A multi-part interlocking longitudinal strip (with corner accessories) is combined with a sealing material to form a telescopic seal between the horizontal and vertical surfaces as listed by GB 2289924 GB 2320068

METHOD D: A longitudinal strip with an incorporated sealant bond breaker is combined with a sealing material to form an elastic seal between the horizontal and vertical surfaces, as listed by EP 1112418

METHOD E: A longitudinal angular interlocking strip with a flexible sealing lip is combined with an adhesive tape whereby the strip has a detachably lockable T shaped head to form a release mechanism to accommodate joint movement as listed by U.S. Pat. No. 4,829,731.

METHOD F: A longitudinal substantially L shaped strip incorporates a third limb to reduce the volume of sealing material required to seal the joint. Sealing material is applied into the strip accordingly to form a seal as listed by GB 2348805

The main disadvantages of the above arrangements that in the case of method A, soft lips perish, shrink, harden and leak in shower areas and as the joint expands the sealing lip looses pressure. In the case of B the exposed sealant is unsightly and often de-bonds or tears under wall movement. The overlapping strips in method C created an unattractive joint line and the butt jointed corner detail may present problems if one wall moves relative to the other. The flexible fin in method E forms the seal and this sealing lip deteriorates in the shower environment. The third limb detailed in method F is incorporated to reduce the volume of sealant required to seal the joint and not to accommodate joint movement.

It is the object of this invention to provide a sealing system that may substantially reduce the aforementioned problems.

According to the present invention there is provided a sealing system comprising of at least two parts being a longitudinal strip profile and a sealing material, both adapted in combination to maintain a sealed joint between typically relatively vertical and horizontal surfaces, the strip profile comprising a first upper limb having an upper limb upper boundary and an upper limb lower boundary between which there extends an upper limb inner face and an upper limb outer face, and from which upper limb inner face and/or upper limb boundaries there extends at least one second outer limb having an outer limb inner boundary attached to the upper limb and an outer limb outer boundary between which outer limb boundaries there extends an outer limb upper face and an outer limb lower face, characterised in that the longitudinal strip profile is semi-flexible and the at least one second outer limb is flexible and further characterised in that there extends from the upper limb inner face and/or the upper limb lower boundary and/or the outer limb lower face and/or the outer limb outer boundary, at least a third flexible inner limb and/or filler material adapted to sealingly engage an uncured sealing material and to aid the full or substantial isolation of the uncured sealing material from the upper limb inner face and/or the outer limb lower face.

Preferably, flexibility in the strip profile may be achieved through adjusting the sectional wall thickness and/or co-extruding flexible material at selected points in the strip profile.

Preferably, the inner limb and/or filler material may form and/or anchor a sealant reservoir and/or directly engage the sealing material with the horizontal surface in substantial isolation from the remainder of the strip profile.

Alternatively, additional inner limbs and/or filler material may extend and/or connect together from the upper limb inner face or upper limb lower boundary and/or the outer limb lower face or outer limb outer boundary.

Preferably, that part of the strip profile in contact with sealing material being typically at the interface between the strip and the horizontal and vertical surfaces has a plurality of ribs and/or recesses and/or barbs and/or holes to contact and grip a sealing material and/or an adhesive material.

Ideally, the outer limb upper face is adapted to throw off water over the complementary sealing material.

In one embodiment the strip may have a flexible lip along the uppermost boundary of the upper limb and the outer most boundary of the outer limb adapted to engage irregular vertical and horizontal surfaces respectively and make the joint more attractive.

Furthermore, the height of the first limb may be reduced through the provision of a least one score line allowing the easy tearing off of a longitudinal section of strip.

The invention will be generally described with reference to the accompanying drawings:

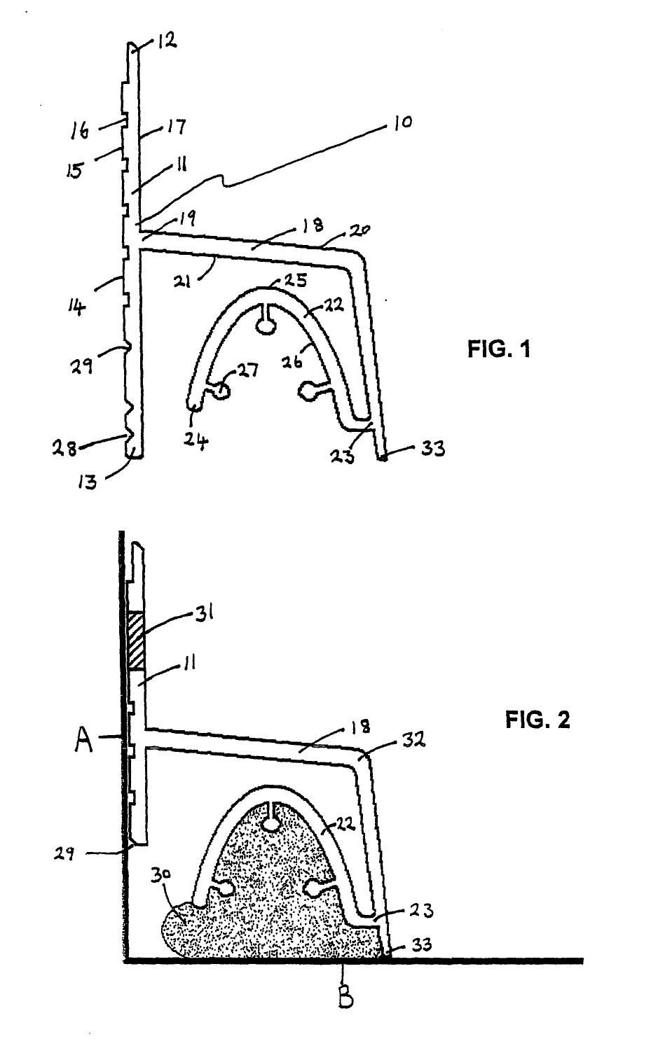

FIG. 1 represents a sectional view of a semi-flexible longitudinal strip profile according to the current invention.

FIG. 2 represents a sectional view of the semi-flexible longitudinal strip profile detailed in FIG. 1 when installed over a joint between a vertical and horizontal surface. A reservoir of sealing material, typically silicon is substantially isolated from the upper limb and outer limb engages the inner limb and the horizontal surface.

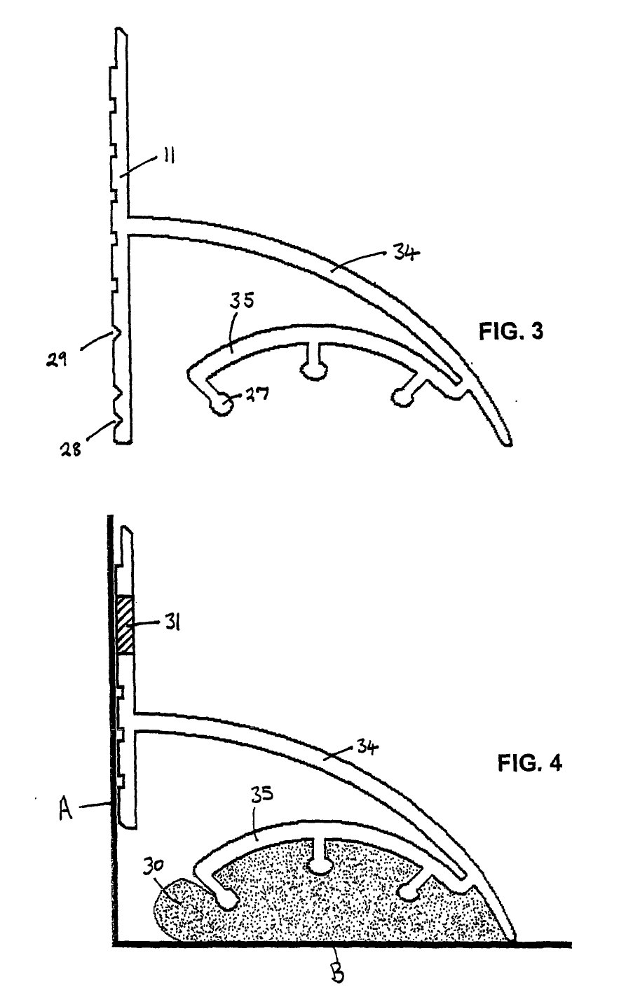

FIG. 3 represents a sectional view of an alternative semi-flexible longitudinal strip profile according to the current invention.

FIG. 4 represents a sectional view of the semi-flexible longitudinal strip profile detailed in FIG. 3 when installed over a joint between a vertical and horizontal surface. A reservoir of sealing material substantially isolated from the upper limb and outer limb engages the third limb and the horizontal surface.

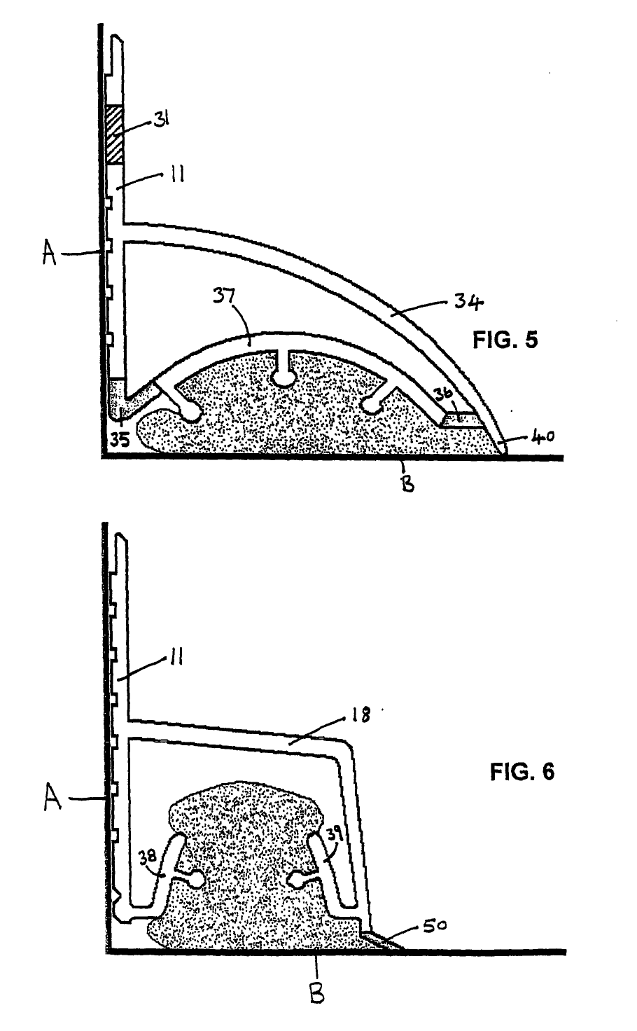

FIG. 5 represents a sectional view of an alternative embodiment of the semi-flexible longitudinal strip profile whereby flexible co-extrusions connect the inner limb with the upper limb and outer limb.

FIG. 6 represents a sectional view of an alternative embodiment of the semi-flexible longitudinal strip profile detailed in FIG. 2. A reservoir of sealing material substantially isolated from the upper limb and outer limb engages two inner limbs and the horizontal surface.

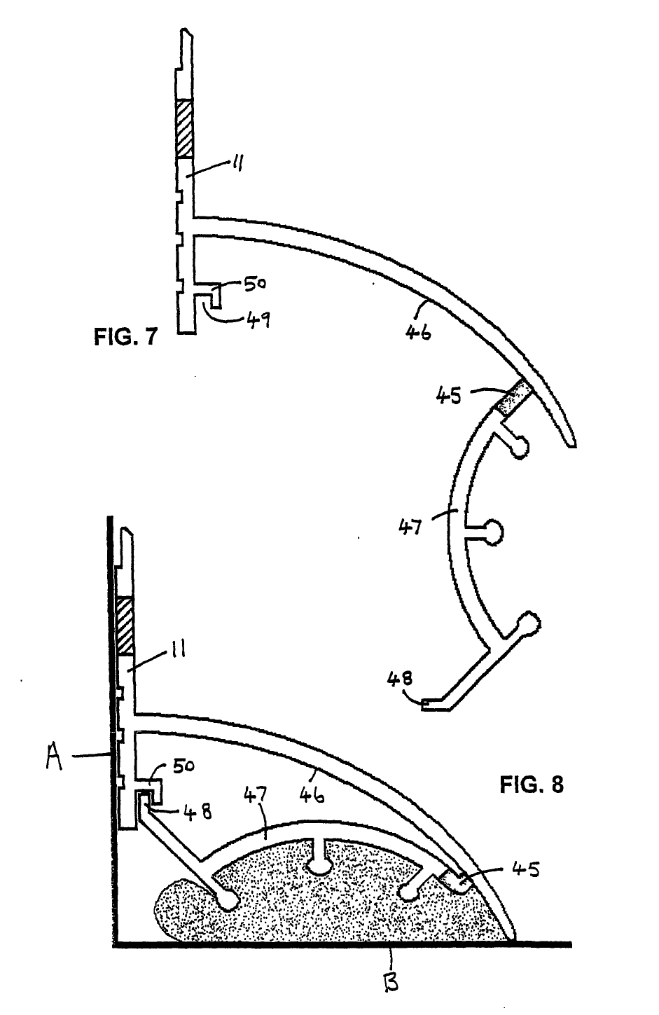

FIG. 7 represents a sectional view of an alternative embodiment of the semi-flexible longitudinal strip profile whereby the strip is detachably self interlocking.

FIG. 8 represents the profile detailed in FIG. 7 after it is interlocked and installed over a joint.

The invention will hereinafter be more particularly described with reference to the accompanying drawings, which show by way of example only, embodiments of the seal according to the invention, in these drawings:

FIG. 1 details a sectional view of a strip profile 10 which has an upper limb 11 having an upper limb upper boundary 12 and a upper limb lower boundary 13 between which there extends an upper limb outer face 14 adapted through a series of ridges 15 and recesses 16 to accommodate and grip an adhesive or sealing material it may engage with a vertical surface A (FIG. 2). The height of the upper limb 11 may be easily reduced through the provision of at least one score line 28 running parallel to the lower boundary 13.

The upper limb 11 has an upper limb inner face 17 from which there extends a flexible outer limb 18 having an outer limb inner boundary 19 attached to the upper limb inner face 17 and an outer limb outer boundary 33 between which there extends an outer limb upper face 20 adapted to throw off water.

The outer limb 18 has an outer limb lower face 21 from which there extends a flexible inner limb 22 having an inner limb inner boundary 33 attached to the outer limb lower face 21 and an inner limb outer boundary 24 between which there extends an inner limb upper face 25 and an inner limb lower face 26 adapted to engage and grip a sealing material 30 (FIG. 2) through the provision of one or more ribs 27.

FIG. 2 details a sectional view the strip profile described in FIG. 1 when installed over a joint defined where vertical surface A (typically a wall) meets a horizontal surface B (typically a shower tray or bath ledge). A section of the strip profile along score line 29 has been removed and strip profile upper limb 11 has been adapted through the provision of holes 31 to accommodate adhesive (typically tile adhesive).

The sealant 30 is solidly engaged by inner limb 22 but substantially isolated from upper limb 11 and outer limb 18. Upper limb 11 and outer limb 18 are semi flexible and in the event of horizontal surface B moving down (typically caused by acrylic bath deflection or timber floor joist shrinkage) or the vertical surface moving back (typically caused by timber stud wall shrinkage) the outer limb 18 will deflect substantially about the axis neck 32 because this limb is not installed under tension.

The sealant 30 and the inner limb 22 are substantially free to move down with the horizontal surface B and the upper limb 11 is substantially free to move back with the vertical surface A. The junction 23 of meeting limbs 18 and 22 is positioned to eliminate or minimize the risk of a gap developing between the outer limb outer boundary 33 and the horizontal surface B in the event of horizontal surface B moving down.

FIG. 3 and FIG. 4 details sectional views of a strip profile similar to that described in FIG. 1 and FIG. 2 respectively.

In FIGS. 3 and 4 the outer limb 34 and inner limb 35 are more substantially curved than those in FIGS. 1 and 2 respectively to accommodate installations where a wider unobtrusive strip is required (typically to span a gap between the horizontal and vertical surfaces). The dynamics that create the capability for joint movement are still incorporated into the strip profile. The stress on outer limb 34 created by joint movement is more evenly distributed over the length of the limb rather than a specific part as in 32 (FIG. 2).

In FIG. 4 a section of the strip profile along score line 29 has been removed and the strip profile upper limb 11 has been adapted through the provision of holes 31 to accommodate adhesive (typically tile adhesive).

FIG. 5 is one embodiment of the invention where the inner limb 37 is attached to the upper limb 11 and the outer limb 34. The introduction of one or more flexible co-extrusions 35 and 36 creates stress release points in the event of joint movement. It should be understood that limb 34 may in various embodiments be attached to the upper most or lowermost boundaries of upper limb 11 (not shown). A flexible fin (not shown) can be co-extruded along the outer boundary 40 of outer limb 34 to accommodate irregular surfaces.

FIG. 6 is another embodiment of the invention wherein two inner limbs 38 and 39 substantially isolate the sealing material from upper limb 11 and outer limb 18. A flexible lip 50 is attached to the outer limb outer boundary.

FIGS. 7 and 8 details yet another embodiment of this invention whereby the strip profile is self interlocking through a flexible co-extrusion 45 connecting the outer limb lower face 46 to the inner limb 47. The inner limb 47 outer boundary 48 engages chamber 49 formed by limb 50 with upper limb 11 and this stabilizes inner limb 47 while cutting miters for meeting strips at corners. In this embodiment the stress on the strip profile is substantially released through the flexibility of the co-extrusion 45 and the easy release of the inner limb outer boundary 48 from the chamber 49.

1. A sealing system comprising of at least two parts being a longitudinal strip profile (10) and a sealing material, both adapted in combination to maintain a sealed joint between typically relatively vertical and horizontal surfaces, the strip profile (10) comprising a first upper limb (11) having an upper limb upper boundary (12) and an upper limb lower boundary (13) between which there extends an upper limb inner face (17) and an upper limb outer face (18), and from which upper limb inner face (17) and/or upper limb boundaries (12, 13) there extends at least one second outer limb (20) having an outer limb inner boundary (19) attached to the upper limb (11) and an outer limb outer boundary (33) between which outer limb boundaries (19, 33) there extends an outer limb upper face (20) and an outer limb lower face (21), characterised in that the longitudinal strip profile (10) is semi-flexible and the at least one second outer limb is flexible and further characterised in that there extends from the upper limb inner face (17) and/or the upper limb lower boundary (13) and/or the outer limb lower face (21) and/or the outer limb outer boundary (33), at least a third flexible inner limb (22) and/or filler material adapted to sealingly engage an uncured sealing material and to aid the full or substantial isolation of the uncured sealing material from the upper limb inner face (17) and/or the outer limb lower face (21).

2. A sealing system as claimed in claim 1, wherein flexibility in the strip profile (10) is achieved through adjustment of the sectional wall thickness and/or or co-extruding flexible material at selected points in the strip profile.

3. A sealing system as claimed in claim 1, wherein the inner limb (22) and/or filler material form and/or anchor a sealant reservoir and/or directly engage the sealing material with the horizontal surface, in substantial isolation from the remainder of the strip profile.

4. A sealing system as claimed in claim 1, wherein additional inner limbs and/or filler material extend and/or connect together from the upper limb inner face (17) or upper limb lower boundary (13) and/or the outer limb lower face (21) or outer limb outer boundary (33).

5. A sealing system as claimed in claim 1, wherein that part of the strip profile (10) in contact with sealing material being typically at the interface between the strip and the horizontal and vertical surfaces has a plurality of ribs and/or recesses and/or barbs and/or holes (31) to contact and grip a sealing material and/or an adhesive material.

6. A sealing system as claimed in claim 1, wherein the outer limb upper face (20) is adapted to throw off water over the complementary sealing material.

7. A sealing system as claimed in claim 1, wherein the strip profile (10) has a flexible lip along the uppermost boundary (12) of the upper limb (11) and the outermost boundary of the outer limb (18) to engage irregular vertical and horizontal surfaces respectively.

8. A sealing system as claimed in claim 1, wherein the height of the first upper limb (11) is reduced through the provision of a least one score line (28) allowing the easy tearing off of a longitudinal section of strip.

9. A sealing system as claimed in claim 1 wherein the third flexible inner limb (22) is adapted to sealingly engage the uncured sealing material and to aid the full or substantial isolation of the uncured sealing material from the upper limb inner face (17) and/or the outer limb lower face (21) by the provision of one or more ribs (27) which extend into the uncured sealing material, the ribs (27) being located on the inner limb lower face (26) between the inner limb inner boundary (23) and the inner limb outer boundary (24).

10. A sealing system as claimed in claim 9 wherein the ribs (27) have substantially bulbous heads which mechanically grip and are imbedded into the sealing material.

11. A sealing system as claimed in claim 3, wherein additional inner limbs and/or filler material extend and/or connect together from the upper limb inner face (17) or upper limb lower boundary (13) and/or the outer limb lower face (21) or outer limb outer boundary (33).

12. A sealing system as claimed in claim 11, wherein that part of the strip profile (10) in contact with sealing material is at the interface between the strip and the horizontal and vertical surfaces and has a plurality of ribs and/or recesses and/or barbs and/or holes (31) to contact and grip a sealing material and/or an adhesive material.

13. A sealing system as claimed in claim 12, wherein the outer limb upper face (20) is adapted to throw off water over the complementary sealing material.

14. A sealing system as claimed in claim 13, wherein the strip profile (10) has a flexible lip along the uppermost boundary (12) of the upper limb (11) and the outermost boundary of the outer limb (18) to engage irregular vertical and horizontal surfaces respectively.

15. A sealing system as claimed in claim 14, wherein the height of the first upper limb (11) is reduced through the provision of a least one score line (28) allowing the easy tearing off of a longitudinal section of strip.

16. A sealing system as claimed in claim 14 wherein the third flexible inner limb (22) is adapted to sealingly engage the uncured sealing material and to aid the full or substantial isolation of the uncured sealing material from the upper limb inner face (17) and/or the outer limb lower face (21) by the provision of one or more ribs (27) which extend into the uncured sealing material, the ribs (27) being located on the inner limb lower face (26) between the inner limb inner boundary (23) and the inner limb outer boundary (24).

17. A sealing system as claimed in claim 16 wherein the ribs (27) have substantially bulbous heads which act as barbs to mechanically grip and be imbedded into the sealing material.
